(19) United States
(12) Patent Application Publication
(10) Pub. No.: US 2013/0095340 A1
(43) Pub. Date: Apr. 18, 2013

(54) HYBRID METHODOLOGY FOR PRODUCING COMPOSITE, MULTI-LAYERED AND GRADED COATINGS BY PLASMA SPRAYING UTILIZING POWDER AND SOLUTION PRECURSOR FEEDSTOCK

(71) Applicants: Govindarajan Sivakumar, Andhra Pradesh (IN); Shrikant Vishwanath Joshi, Andhra Pradesh (IN)

(72) Inventors: Govindarajan Sivakumar, Andhra Pradesh (IN); Shrikant Vishwanath Joshi, Andhra Pradesh (IN)

(73) Assignees: NEW MATERIALS ( ARCI) DEPARTMENT OF SCIENCE AND TECHNOLOGY, Govt. of India, Haryana, IN (US); INTERNATIONAL ADVANCED RESEARCH CENTRE FOR POWDER METTALLURGY AND

(21) Appl. No.: 13/484,613

(22) Filed: May 31, 2012

(30) Foreign Application Priority Data
Oct. 17, 2011 (IN) 2965/DEL/2011

(51) Int. Cl. C23C 4/12; B32B 3/10; B32B 15/01; B82Y 40/00

(52) U.S. Cl. 428/548; 427/448; 428/195.1; 977/890

(57) ABSTRACT

A method of producing a composite plasma spray coating using simultaneous feeding of powder and solution precursor feedstock in a plasma spray gun is disclosed, comprising the steps of a) spraying a powder feedstock comprising micron sized particles into a plasma spray plume; and b) spraying a liquid feedstock comprising liquid precursor solution into the plasma spray plume, wherein the spraying of the powder feedstock and spraying of the liquid feedstock are independently controllable. The method allows control of coating composition and microstructure to deposit nanostructured and microstructured layers either sequentially to form layered coatings, or simultaneously to form either composite coatings or continuously gradient coatings to address diverse applications. Thermal barrier coatings produced using the new method have demonstrated twice the life compared to conventional air plasma sprayed coatings.

### FIELD OF THE INVENTION

The present invention is related to a deposition methodology or process for forming composite, multi-layered and graded coatings with more than one type of feedstock involving simultaneous or sequential feeding of solution precursors as well as powders. More specifically, the invention relates to a novel scheme of introducing the powder and solution precursor feedstock materials into a plasma spray, or any other thermal spray, system to achieve engineered and unique microstructures to enhance the functional characteristics of coatings.

### DESCRIPTION OF THE RELATED ART

Thermal spray coating is a useful industrial process that involves formation of a protective or functional layer or coating through successive layer-by-layer deposition of feedstock material using different high temperature, high velocity sources of energy such as those generated by a plasma, oxy-fuel combustion or arc. The feedstock materials including metals, alloys, ceramics, cermets or combinations thereof, when injected into any of the above high energy sources, are thermally softened/melted and directed towards the substrate to form a coating. The feedstock materials are usually supplied in the form of powders, which are typically in the size range of 10 to 125 microns. Many different thermal spray variants are available, the more popular among them being Plasma Spray, Detonation Spray, High-Velocity Oxy-Fuel (HVOF) spray, High-Velocity Air-Fuel (HVAF) spray, Cold Spray, Flame Spray, Wire-Arc Spray etc. Conventionally, the above techniques have involved injection of feedstock materials primarily in the form of powder particles, and occasionally also as wires or rods, into the high temperature zone (formed by plasma, combustion, arc, etc.) wherein they undergo full/partial melting and acceleration by the gas stream before impacting the substrate to form a coating. Repetitive impact of the fully/partially molten particles at high velocity, each forming a “splat”, eventually leads to the formation of a coating layer of desired thickness to be used for various applications.

The above processes, although different in terms of the inherent source of thermal energy, are all utilized industrially, with the properties of the deposited layer being dependent on the specific thermal spray variants employed. The applications of thermally sprayed coatings are all expansive and extend to various engineering components exposed to different types of wear, corrosion and high temperature situations, to enhance the service life of components as well as their performance. For example, in a typical application demanding high temperature protection to the underlying substrate, deposition of a ceramic zirconia based thermal barrier coating (TBC) extends life of gas turbine components operating at high temperatures. Similarly, deposition of appropriate coatings through judicious choice of feedstock material can impart any necessary or desired functional property such as wear-, corrosion-, or oxidation-resistance to the surface.

Powder feeding techniques used in conjunction with the different thermal spray variants, particularly plasma spraying, have been improved upon by modifications and attachments to the plasma spray torch as described, for example, in U.S. Pat. No. 3,987,937 to Coucher, U.S. Pat. No. 4,674,683 to Fabel, and U.S. Pat. No. 5,013,883 to Fuimefreddo et al., to improve the spraying efficiency. In most of the cases, the primary plasma producing gas is used for carrying the powder feedstock to the high temperature plasma plume and injecting it radially into the plasma stream. Although some variants of plasma spray and a few other thermal spray techniques adopt axial powder injection to facilitate particle heat-up and acceleration, a majority of the plasma spray systems use radial powder injection ports. Simultaneous feeding of powder and liquid feedstock during plasma spraying has been disclosed by Skoog et al. (U.S. Patent Publication No. US20060222777). However, the use of this equipment to produce composite nanostructured/microstructured coating is not disclosed. The essence of the above disclosure is a method to apply a plasma-sprayed coating to a substrate using fine particles suspended in a carrier liquid to overcome the problem of clogging in conventional powder feed systems. The use of solution precursors that lead to in situ formation of fine nano-sized particles through a reaction is not envisaged.

More recently, nanostructured materials have been reported to yield improved performance in terms of hardness, toughness, and wear-resistance, than conventional micron-sized materials. Similarly, the consolidation of nanostructured materials through thermal spraying has also been reported to exhibit improved characteristics and performance. However, nanosized powders cannot be directly applied through thermal spraying due to problems associated with their poor flowability and, therefore, have to be inevitably agglomerated to acceptable sizes to enable feeding. U.S. Patent Publication US20070134432A1 discloses a method of forming duplex nanostructured coatings by thermal spraying a reconstituted nanostructured material to form a coating comprising more than one structural state but does not envision use of any solution precursor. Even if the particles are agglomerated to facilitate feeding, the particles once exposed to high temperature plumes of plasma or detonation or HVOF spray undergo unavoidable grain growth and the nanostructure cannot be retained. Additionally, the cost involved in first synthesizing the nanostructured materials and their subsequent agglomeration is unattractive for a vast majority of industrial applications.

In order to address the above issues, spraying of liquid based feedstock has been proposed as a potential route for spraying nanostructured materials. Research publications by Karthikeyan et al. (Mat. Sci. Eng., 238, 1997), U.S. Pat. No. 5,609,921 to Gitzhofer et al. and U.S. Pat. No. 6,447,848 B1 to Chow et al., are some of the pioneering works in the field of liquid feedstock based thermal spraying using either precursor solutions with desired metal ions or nanoparticle suspensions in a solvent. Both the above approaches provide fine splats, by virtue of the fact that nanoparticles are either generated in situ in case of precursor solutions or are originally present in the suspension, and thereby lead to formation of nanostructured coatings. The delivery system for solution precursors has been documented in U.S. Pat. No. 7,112,758 B2 to Ma et al. Ever since solution based spraying was first proposed, its use has been primarily directed towards oxide-based coatings as reflected from many published papers and in U.S. Pat. No. 7,563,503 B2 to Gell et al. Multilayered thermal spray coatings incorporating both nanostructured and microstructured layers have been disclosed previously in U.S. Patent Publications US20080072790A1 and US20070134432A1. In US20080072790, use of sequential spraying of powder and liquid feedstocks to produce finely structured metallic and cermet coatings via high-velocity oxy-fuel spraying is disclosed, while in US20070134432A1 the layered structure is formed by using reconstituted nanostructured material and involves no liquid feedstock. The present method is intended to be an improvement over these methods.

As disclosed in published papers as well as in a few patents worldwide, the solution-precursor based thermal spray deposition yields coatings with distinctive features like fine splat morphologies, homogeneous fine pore architecture, phase purity, vertical cracks, nanometer sized grains etc. as opposed to the lamellar structure obtained from conventional powder based plasma spraying. On the other hand, the conventional technique involving a powder feedstock offers much higher throughput compared to solution-based processes. The present invention is a complementary approach to achieve substantial improvements over the existing solution precursor based spray coatings as well as the conventional powder based thermal spray coatings by combining the benefits of both to produce composite, multilayered and graded coatings.

### SUMMARY OF THE INVENTION

A method of producing a composite plasma spray coating using simultaneous feeding of powder and liquid feedstock in a plasma spray gun is disclosed, comprising the steps of a) spraying a powder feedstock comprising micron sized particles into a plasma spray plume; and b) spraying a liquid feedstock comprising liquid precursor solution into the plasma spray plume, wherein the spraying of the powder feedstock and spraying of the liquid feedstock are independently controllable; and using the steps a) and b), forming a surface coating on a substrate, incorporating micron sized splats corresponding to the powder feedstock and nanometer sized splats corresponding to the liquid feedstock, wherein the nanometer sized splats are formed by reaction of the constituents in the liquid precursor solution within the plasma plume.

The powder feedstock used in the method of the invention comprises metal or alloy powder including one or more of Ni, Co, Cr, Al, and Y, or alternatively, one or more ceramic powders including Y₂O₃, ZrO₂, Al₂O₃, TiO₂, ZnO, Fe₂O₃, Cr₂O₃, and La₂O₃. The liquid feedstock comprises precursor solution configured to form one or more ceramics chosen from Y₂O₃, ZrO₂, Al₂O₃, TiO₂, ZnO, Fe₂O₃, Cr₂O₃, and La₂O₃. The spraying of the powder and liquid feedstocks are independently controllable to provide from 0% to 100% of the constituents present in the deposited coating.

The method of the invention can be used to produce a composite coating of nanostructured and microstructured layers formed by successively spraying alternate layers using liquid feedstock and powder feedstock. Alternatively, the coating can be a gradient coating comprising fully microstructured constituents near the substrate and fully nanostructured constituents near the surface or vice versa. The size and distribution of porosity can also be controlled.

A coated article produced using the method of the invention, can be a metal substrate coated with metallic or ceramic particles or both. A coated article can comprise a metallic bond coat comprising one or more metals of Ni, Co, Cr, Al and Y; and a ceramic top coat comprising one or more of Y₂O₃, ZrO₂, Al₂O₃, TiO₂, ZnO, Fe₂O₃, Cr₂O₃, La₂O₃ in various proportions. The ceramic top coat could be formed of microstructured and nanostructured layers, or alternatively, could comprise a gradient layer with zero % ceramic constituent in the bond coat to 100% ceramic constituent in the top coat. The gradient layer could be comprise a nanostructured ceramic incorporating nano-pores.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 represents the frontal view of an experimental arrangement for feeding solution precursor as well as the powder feedstock. This enables powder feeding in addition to solution precursor feeding in a controlled manner, either simultaneously or sequentially.

FIG. 2 shows the schematic of the process involving the solution precursor feeding as well as the powder feedstock.

FIG. 3 is a cross-sectional scanning electron micrograph of YSZ+NiCoCrAlY coating, formed by simultaneous feeding of YSZ forming solution precursor and NiCoCrAlY powders during plasma spraying. The solution precursor feeding was controlled to enable YSZ to be formed in situ and distributed along with the NiCoCrAlY splats.

FIG. 4 is the Energy Dispersive Spectra of the YSZ+NiCoCrAlY coatings showing the presence of elemental Y and Zr, besides Ni, Co, Cr and Al, in the composite coating to confirm co-deposition of YSZ from the solution precursor and NiCoCrAlY from the powder.

FIG. 5 shows a cross-sectional scanning electron micrograph of a “composite” YSZ coating at high magnification revealing the distribution of fine sized features of in situ formed YSZ particles from the solution precursor and lamellar features of YSZ powder.

FIG. 6 shows the phase stability of composite YSZ coating with the presence of preferred tetragonal zirconia alone without any phase transformation, while the conventional plasma sprayed YSZ coatings with powder feedstock reveal presence of monoclinic zirconia phase also.

FIG. 7 shows the cross-sectional scanning electron micrograph of a two-layered YSZ top coat generated through sequential feeding of powder and solution precursor feedstock along with a NiCoCrAlY bond coat.

FIG. 8 shows the superior relative thermal cycling performance of the two-layered YSZ coating with sequentially fed powder and solution precursor feedstock as compared to a conventional plasma sprayed YSZ coating utilizing powder feedstock alone.

FIG. 9 shows the cross-sectional scanning electron micrograph of a graded YSZ+NiCoCrAlY coating generated using simultaneous feeding of a YSZ forming liquid precursor solution and NiCoCrAlY powder.

### DETAILED DESCRIPTION OF THE PREFERRED EMBODIMENTS

The proposed invention relating to the development of novel composite, multi-layered and graded coatings will be described in the following section referring to the sequentially numbered figures. The above-mentioned objectives are achieved through simultaneous feeding of solution precursor and powder feedstock materials into the hot zone of any thermal spray system, although specifically illustrated in this application for a plasma spray system.

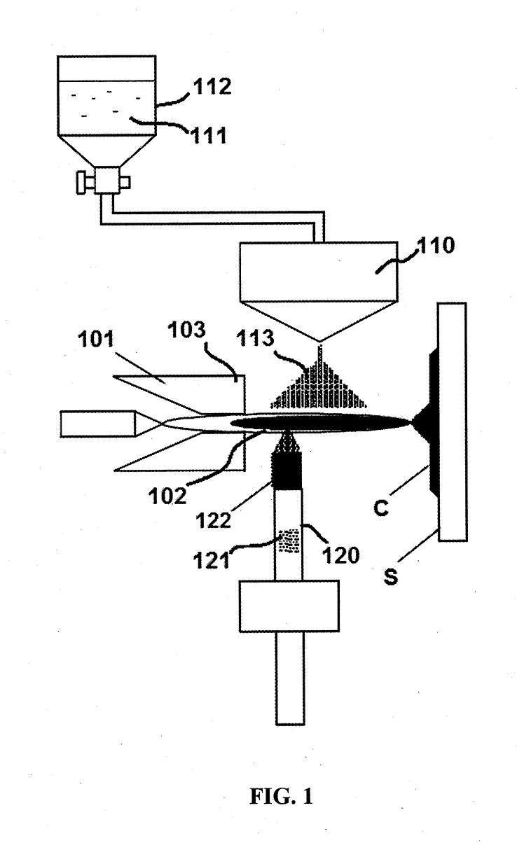

In its primary embodiment, the method of the invention is shown schematically in FIG. 1. As shown in FIG. 1, plasma spray gun 101 is fitted with atomizer 110 to spray solution precursor feedstock and powder feeder 120 to spray powder feedstock into the plasma plume 102. Atomizer arrangement 110 is fed pressurized solution precursor feedstock 111 by pressurized liquid precursor tank 112, resulting in atomized droplets 113 of liquid precursor solution feedstock 111 entering the plasma plume. Powder feeder 120 incorporates air or gas feed that entrains powder 121 from a hopper (not shown) and emits a powder stream 122 into the plasma plume 102. As the equipment is operated, coating C is deposited on substrate S. The atomizer 110 and powder feeder 120 are affixed to the nozzle portion 103 of the plasma torch 101.

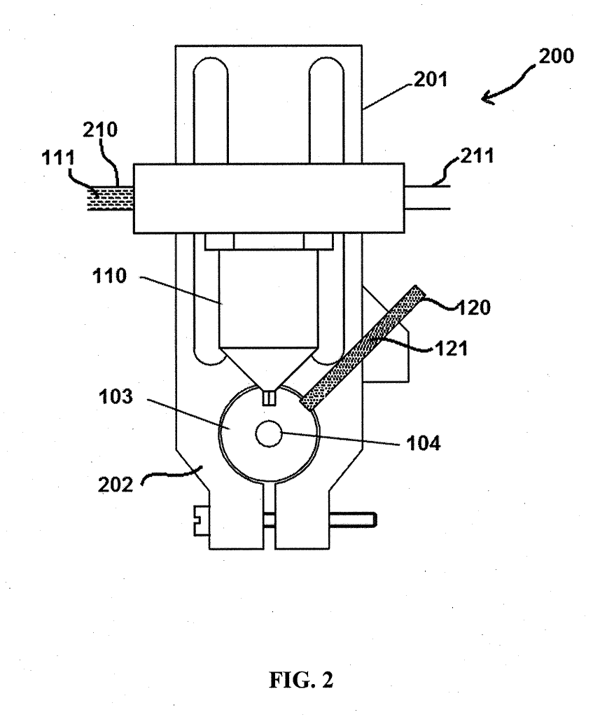

A detailed view of the combined powder and liquid feed arrangement 200 is shown in FIG. 2, fitted to the nozzle portion 103 of the plasma torch 101, looking upwards from below the torch. The arrangement 200 comprises bracket 201 holding the liquid atomizer 110 and powder feeder 120, while clamp 202 is used to affix it to the nozzle 103 of the plasma torch. Plasma plume outlet portion 104 is also shown in FIG. 2. Although radial injection of powder and solution precursor feedstock perpendicular to the central line of the plasma spray plume axis is depicted in the figure, injection of both feedstock at varying and independently controllable angles, including both inward and outward with respect to the plume direction, is possible to yield the best coating characteristics for a specific powder or solution precursor feedstock. Accordingly, the feedstock delivery attachment for the plasma spray gun is fabricated to accommodate the atomizer for feeding the solution precursor as well as a powder feeding hose as shown in FIG. 2.

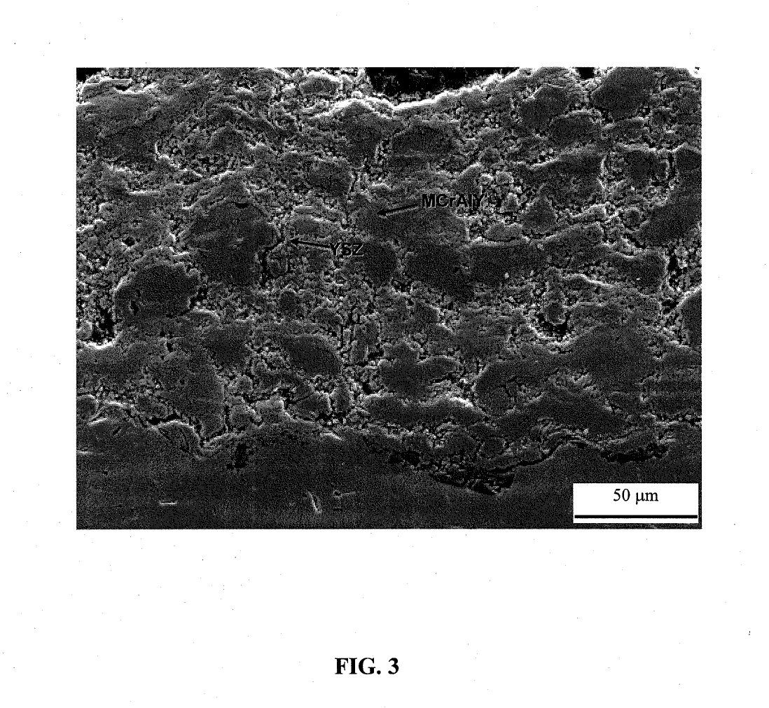

The methods of the invention are further illustrated with reference to several examples of thermal barrier coatings in FIG. 3 to FIG. 9. Thermal barrier coatings essentially constitute a ceramic top coat providing the thermal insulation, deposited over a metallic MCrAlY type alloy bond coat providing oxidation and/or corrosion resistance, deposited on a component substrate such as a turbine blade. The targeted functionalities are wide ranging, as explained in the following embodiments.

Top coat: Yttria-stabilized zirconia (YSZ) coating is the popular choice as a top coat in case of thermal barrier coatings because it best meets all desired property requirements, particularly high thermal expansion coefficient, low thermal conductivity and good chemical stability at high temperature. However, YSZ is limited by its ordinary phase-microstructure stability and sinterability upon prolonged exposure to elevated temperatures. An engineered microstructure formulated based on composite, multi-layered or graded architecture can provide a promising solution to the above issues. A composite layer involving conventional powder based YSZ and nanostructured YSZ formed from a solution precursor can mutually provide reduced thermal conductivity as well as better sintering resistance. Similarly, a multilayered coating comprising a nanostructured solution precursor based-YSZ and conventional powder based YSZ layers can assist in reducing the kinetics of bond coat oxidation. A graded structure involving a solution precursor formed YSZ and conventional NiCoCrAlY powder can effectively reduce thermal expansion mismatch as compared to a TBC architecture involving a conventional duplex structure of NiCoCrAlY and YSZ.

Bond coat: The bond coat, apart from providing a more compatible interface between the substrate and top coat, is required to impart requisite high temperature oxidation and corrosion resistance. A thermally grown oxide (TGO) on the bond coat surface is known to act as a bather to further bond-coat oxidation and addition of secondary phases involving Zr, Y has been found to enhance adherence of TGO with the bond coat.

Accordingly, the various embodiments of this invention provide a suitable solution to address the above requirements through various processing means as illustrated further.

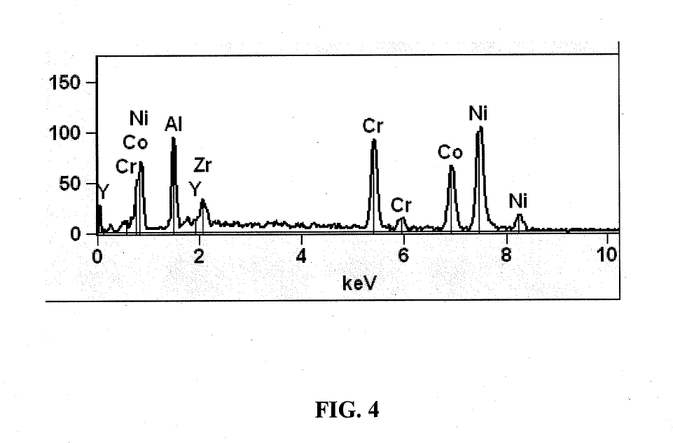

One embodiment of the invention is illustrated in the composite coating shown in FIG. 3, which is the cross-sectional scanning electron micrograph of a YSZ+NiCoCrAlY coating, formed by simultaneous feeding of a YSZ forming solution precursor and a NiCoCrAlY powder. The presence of YSZ can be surmised from the distinct fine splat sizes compared to bigger splat sized NiCoCrAlY as evident in FIG. 3. FIG. 4, which is the Energy Dispersive Spectra (EDS) of the YSZ+NiCoCrAlY coating corresponding to FIG. 3, also confirms the presence of elemental Zr and Y. The microhardness of the composite YSZ+NiCoCrAlY coating also improved to 724±124 HV_{0.1} from 514±41 HV_{0.1} for conventional NiCoCrAlY coating alone, measured at 100 grams of load using a microhardness tester. The above increase in microhardness shows strengthening by the nanostructured YSZ particles dispersed in the NiCoCrAlY matrix. Through the above embodiment of the invention, improvements in oxidation resistance, creep resistance and strength can accrue, besides reduced co-efficient of thermal expansion mismatch between pure bond coat and pure ceramic layers of TBC structure.

Another embodiment of the invention relates to the deposition of composite YSZ coatings by simultaneous feeding of a YSZ-forming solution precursor as well as YSZ powder feedstock. During spraying of YSZ powder particles with 6-8 wt % yttria using prior art processes, formation of the undesirable monoclinic zirconia phase is a usual phenomenon. Furthermore, in conventional powder-based YSZ coatings, the presence of defects involving bigger splats and considerably larger pores usually results in horizontally oriented cracks, which propagate parallel to the interface to accelerate the failure through spallation of the YSZ layer. These aspects were addressed in the solution precursor based prior art YSZ coatings with reduced splat sizes, that formed in situ vertical cracks and nanosized pores. However, the solution precursor based coatings are reported to provide marginally higher thermal conductivity, i.e., less thermal insulating effect, than the YSZ powder based coatings due to reduced defects. Another aspect of solution precursor based coatings is the considerably reduced productivity compared to the conventional powder based coatings.

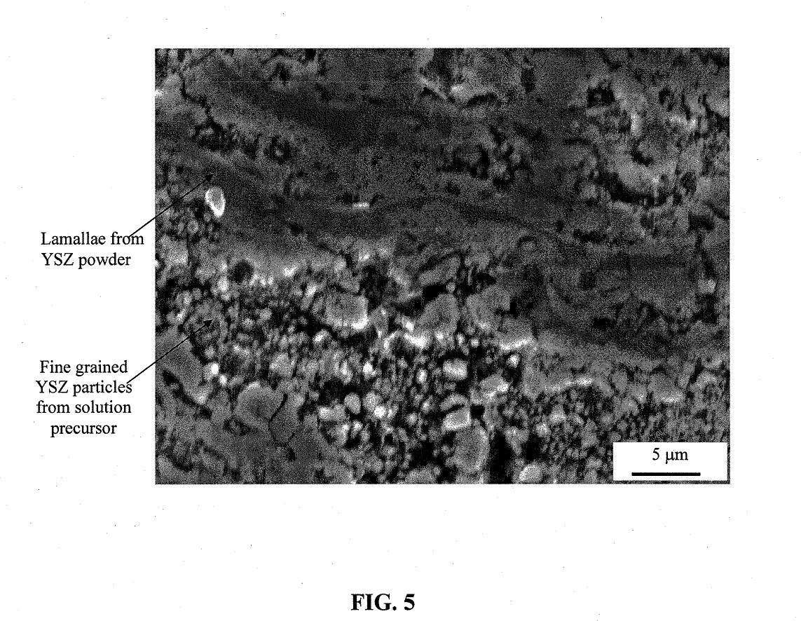

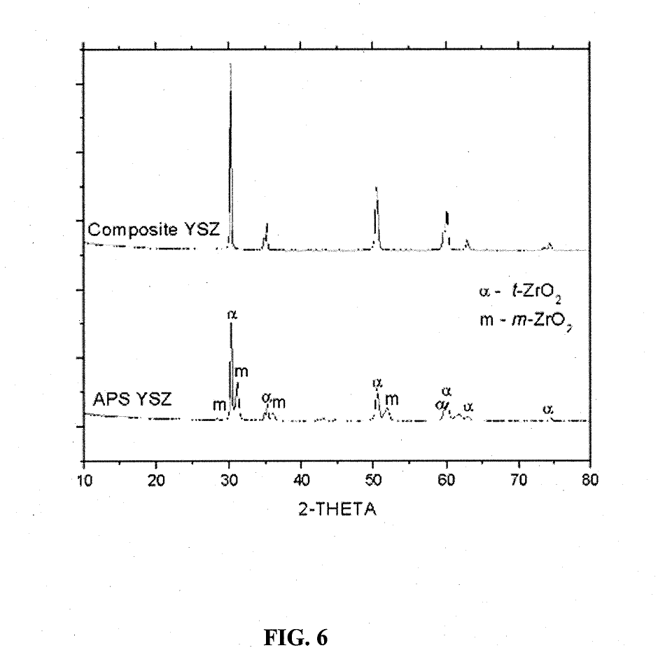

The methods of the present invention address the above drawbacks by enhancing the inherent characteristics of conventional powder based YSZ coating through the simultaneous feeding of solution precursor feedstock leading to substantial improvement in the phase/microstructural control. FIG. 5 shows the cross-sectional scanning electron micrograph of the composite YSZ coating at high magnification revealing the distribution of fine nanometer sized features relating to in situ formed YSZ particles from the solution precursors as well as molten micron-sized lamellar features from YSZ powder feedstock Additionally, FIG. 6 shows the phase stability of composite YSZ coating with the presence of preferred tetragonal zirconia phase without any secondary phases. The microhardness of the composite YSZ coating was found to be 1221±150 HV_{0.1} as against around 1043±139 HV_{0.1} for conventional powder based YSZ coating, measured at 100 grams of load using microhardness tester. The increased hardness is a measure of better cohesion between the nano-sized and micron-sized YSZ particles and, more importantly, absence of unacceptable defects such as horizontal cracks within the coating. Based on the above characteristics, the present embodiment imparts a complementary augmentation of properties from both powder and solution precursor based coating with favorable thermal conductivity, less permeation of oxides and, thereby, enhanced thermal cyclic life of the coating.

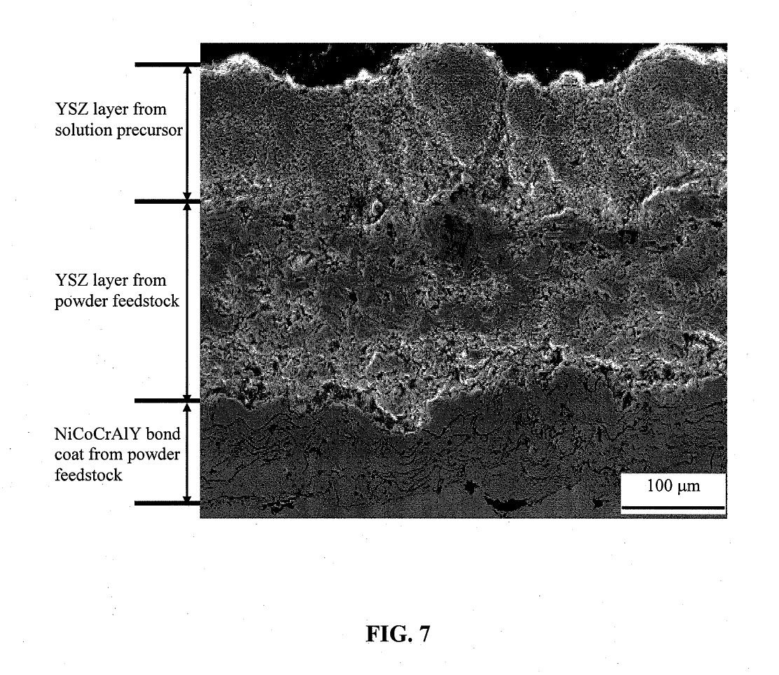

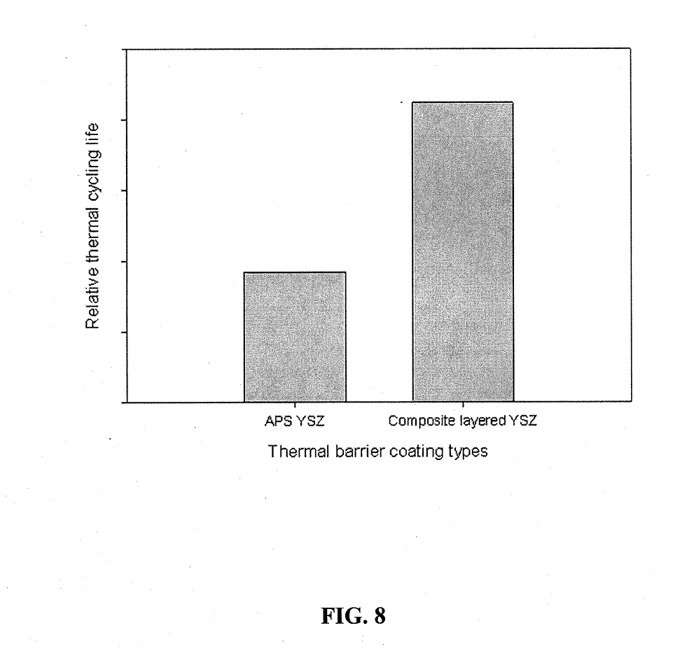

In another embodiment, a layered architecture is employed with the top ceramic coat divided into two segments, comprising a solution precursor based YSZ layer applied over a pre-deposited conventional powder based YSZ layer. FIG. 7 shows the cross-sectional scanning electron micrograph of such a double-layered top coat generated from powder and solution precursors along with a NiCoCrAlY bond coat, all layers being deposited on a super alloy substrate. Usually, a certain optimum porosity level is desired in the top ceramic layer of conventional duplex TBCs, since a very dense ceramic layer is prone to premature spallation due to its inability to accommodate thermal stresses while a highly porous ceramic layer leads to rapid degradation of the underlying bond coat due to ingress of oxidizing/corrosive species. Considering the above failure mechanisms, one of the methods disclosed in the present invention is to provide either a gradient or multi-layered architecture towards improving the durability of YSZ based TBCs. As seen from FIG. 7, the presence of nano-sized pores and the sub-micron sized YSZ particles from the solution precursor can possibly provide a fine grained dense YSZ layer structure resulting from solution precursor plasma spraying at the top surface over a significantly more porous microstructure typical of conventional powder-based YSZ coating. Such a structure is promising for obtaining a thermal barrier coating that has relatively superior strain tolerance and also suppresses the ingress of oxidizing/corrosive species. FIG. 8 shows the relative thermal cycling performance of powder based YSZ coating and double layered YSZ coatings tested at 1100° C. Such an invention leads to significant improvement in performance of TBCs tested through thermal cyclic studies at 1100° C. cycles (20 minutes heating time, 40 minutes holding time and 20 minutes cooling).

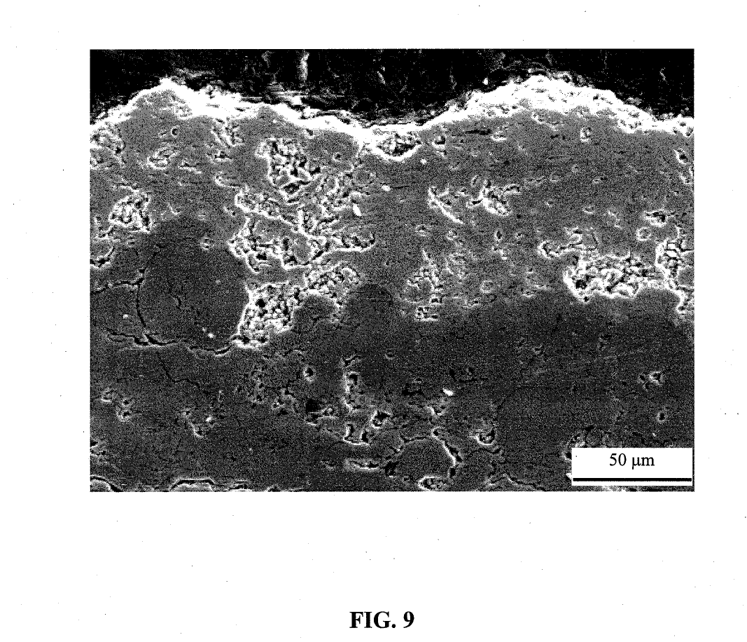

Another embodiment involves demonstration of gradient coating architecture involving gradual compositional variation of the solution precursor formed YSZ and powder based NiCoCrAlY coatings through continuous control of their individual feeding rates during simultaneous feeding of the solution precursor and powder feedstocks. FIG. 9 shows the cross-sectional scanning electron micrograph of a graded YSZ+NiCoCrAlY coating generated using a YSZ forming precursor solution and NiCoCrAlY powder. The graded thermal barrier structure with continuous variation in microstructure exhibits unique mechanical properties but, even more significantly, has the potential to enhance the functional characteristics by imparting improved spallation resistance. Additionally, the presence of nano-sized YSZ along with nano-pores, exhibits better sintering resistance and reduced ingress of oxygen than the powder based YSZ leading to improved life. Intimate mixing of nano-sized YSZ particles with micron-sized NiCoCrAlY generates a unique combination of material characteristics and, thereby, a better performance.

The methods of the invention can be used to produce graded composition coatings using metallic and ceramic powders in various combinations. The metallic powders can be any metal, for example, Fe, Ni, Co, Cr, Al, Y or a combination thereof, to produce coatings of desired properties and functionality, including but not limited to those detailed in the above examples. The ceramic powders can be any oxide or other ceramic powder, including one or more of Al₂O₃, TiO₂, Fe₂O₃, ZnO, La₂O₃, Y₂O₃, ZrO₂, and Cr₂O₃, as may be required to obtain desired thermal properties and microstructural stability in the coating as detailed in the above examples. Similarly, the solution precursors used to produce nanostructured constituents can be tailored to form nanostructured splats or grains containing one or more of Al₂O₃, TiO₂, Fe₂O₃, ZnO, La₂O₃, Y₂O₃, ZrO₂, and Cr₂O₃, or any other ceramic, including those as shown in the examples and embodiments of the invention.

The above embodiments introducing novel routes for depositing coatings, and inferences from the characterization studies performed on the resulting coatings, indicate that the present invention bears obvious promise to extend the service life of components beyond what is possible by employing the conventional coatings. The introduction of a second phase or porosity in a controlled manner in the composite or multilayered or graded coating allows tailoring of various mechanical, thermal and wear characteristics specific to application demands. The potential applications of the above invention are not just limited to gas turbine components like combustion liners and airfoils but can also be extended to diesel engine pistons, valves, cylinder heads, casting molds etc.

The invention is a description of certain embodiments, partially shown and discussed herein. Based on the claimed invention, various changes relevant to modification of the system or novel material combinations may be made to expand the scope of the invention.

The essentiality of the present invention lies in the idea of combined feeding of powder as well as a solution in the form of a precursor or suspension to improve significantly the quality of the coatings and the range of architectures conventionally possible. This is realized through the arrangement of the powder feeding attachment along with the atomizer meant for solution delivery, as shown in the frontal view of the feedstock delivery arrangement depicted in FIGS. 1 and 2. Although specifically exemplified for a plasma spray system in this figure, such a simultaneous powder and solution feeding arrangement can be equally extended to other thermal spray systems also.

The main motivation for the above development is the additional benefits that this improved method offers for achieving enhanced mechanical and physical properties of the coatings along with the possibility of expanding their basic functionality. In view of the above, the present invention is related to dual feeding of solution as well as powder feedstock into the plasma plume at a pre-determined ratio to achieve novel coatings with unique microstructure. Composite, layered and graded coatings can all be achieved by this improved method, with intent to improve the performance of the existing coatings.

The novel methods of the invention, although illustrated using plasma spray process, are generally applicable to any thermal spray process as mentioned in the above embodiments and as delineated in the accompanying claims. Similarly, even though relevance to thermal barrier coating applications is specifically discussed above as an example, they also have far more wide-ranging application relevance.

What is claimed is:

1. A method of producing a composite plasma spray coating using simultaneous feeding of powder and liquid feedstock in a plasma spray gun comprising the steps of:
a) spraying a powder feedstock comprising micron sized particles into a plasma spray plume; and
b) spraying a liquid feedstock comprising liquid precursor solution into the plasma spray plume, wherein the spraying of the powder feedstock and spraying of the liquid feedstock are independently controllable; and
using the steps a) and b), forming a surface coating on a substrate incorporating micron sized splats corresponding to the powder feedstock and nanometer sized splats corresponding to the solution precursor feedstock, wherein the nanometer sized splats are formed by reaction of the constituents in the liquid precursor solution within the plasma plume.

2. The method of claim 1, wherein the powder feedstock comprises metal or alloy powder including one or more of Ni, Co, Cr, Al, and Y.

3. The method of claim 1, wherein the powder feedstock comprises one or more of Al₂O₃, TiO₂, Fe₂O₃, ZnO, La₂O₃, Y₂O₃, ZrO₂, and Cr₂O₃.

4. The method of claim 1, wherein the liquid feedstock comprises a precursor solution configured to form one or more of Al₂O₃, TiO₂, Fe₂O₃, ZnO, La₂O₃, Y₂O₃, ZrO₂, and Cr₂O₃.

5. The method of claim 1, wherein the spraying of the powder and solution precursor feedstocks are independently controlled to achieve a desired coating composition ranging from 0% to 100% of the constituent provided by either feedstock.

6. The method of claim 1, wherein the coating is a composite of nanostructured and microstructured layers formed by successively spraying alternate layers using solution precursor feedstock and powder feedstock.

7. The method of claim 1, wherein the coating is a gradient coating comprising fully microstructured constituents near the substrate and fully nanostructured constituents near the surface.

8. The method of claim 6, wherein the size and distribution of porosity is controlled by varying the plasma spray conditions.

9. A coated article produced using the method of claim 1 wherein a metal substrate is coated with metallic or ceramic particles or both.

10. The coated article of claim 9, further comprising:
a metallic bond coat comprising one or more metals of Ni, Co, Cr, Al and Y; and
a ceramic top coat comprising one or more of Al₂O₃, TiO₂, Fe₂O₃, ZnO, La₂O₃, Y₂O₃, ZrO₂, and Cr₂O₃, in various proportions.

11. The coated article of claim 10, wherein the ceramic top coat comprises layers of microstructured and nanostructured layers.

12. The coated article of claim 10, wherein the coating comprises a gradient layer with zero % ceramic constituent in the bond coat to 100% ceramic constituent in the top coat.

13. The coated article of claim 12, wherein the gradient layer comprises nanostructured ceramic incorporating nano-pores.

14. The method of claim 7, wherein the size and distribution of porosity is controlled by varying the plasma spray conditions.
